(19) United States
(12) Patent Application Publication
(10) Pub. No.: US 2026/0330345 A1
(43) Pub. Date: Oct. 22, 2026

(54) ADJUSTING PRIORITIZATION OF TAGGED BUG TICKETS IN A SOFTWARE STACK

(71) Applicant: International Business Machines Corporation, Armonk, NY (US)

(72) Inventors: Tara ASTIGARRAGA, Fairport, NY (US); Andrew Christian Morrell HICKS, Highland, NY (US); Paulina ACEVEDO, Tucson, AZ (US); Michael Terrence COHOON, Fishkill, NY (US); Michael E. GILDEIN, Wappingers Falls, NY (US)

(21) Appl. No.: 19/181,850

(22) Filed: Apr. 17, 2025

(51) Int. Cl. G06Q 10/0631; G06F 11/3698

(52) U.S. Cl. CPC G06Q 10/06311; G06F 11/3698

(57) ABSTRACT

Adjusting prioritization of tagged bug tickets in a software stack based on comparing tags of one tagged bug ticket to the tags of other tagged bug tickets. Based on the number of tagged bug tickets that are related to a common problem, a priority for the related tagged bug tickets can be adjusted. Each of the related tagged bug tickets may originate from different levels of the software stack or from the same level of the software stack.

### BACKGROUND

The present invention relates to software stacks, and more specifically, to adjusting the priority for tagged bug tickets that was previously assigned a priority.

Complex computing environments often contain multiple software stacks, with each stack including various components, services, applications, and middleware. A common structure for stacks is to separate the code bases and bug tickets for each piece of the stack into self-contained repositories.

### SUMMARY

Embodiments include a method, which includes executing a software stack on a plurality of computing systems. The method further includes detecting one or more problems at different levels of the software stack by monitoring the plurality of computing systems. The method further includes generating, using one or more processors, a plurality of bug tickets for the different levels of the software stack based on the detected one or more problems. The method further includes tagging the plurality of bug tickets based on one or more rules. The method further includes assigning a resolve priority to each of the plurality of tagged bug tickets. The method further includes comparing the plurality of tagged bug tickets to each other to identify tagged bug tickets that result from a common problem in the software stack and adjusting the resolve priority of the identified tagged bug tickets based on a number of the identified tagged bug tickets.

Embodiments include a computer system, which includes a processor set. The computer system further includes one or more computer-readable storage media and program instructions stored on the one or more computer-readable storage media to cause the processor set to perform operations. The operations include executing a software stack on a plurality of computing systems. The operations further include monitoring, using one or more processors, the plurality of computing systems. The operations further include detecting one or more problems at different levels of the software stack. The operations further include generating, using one or more processors, a plurality of bug tickets for the different levels of the software stack based on the detected one or more problems. The operations further include tagging the plurality of bug tickets based on one or more rules. The operations further include assigning a resolve priority to each of the plurality of tagged bug tickets. The operations further include comparing the plurality of tagged bug tickets to each other to identify tagged bug tickets that result from a common problem in the software stack and adjusting the resolve priority of the identified tagged bug tickets based on a number of the identified tagged bug tickets.

Embodiments include a computer program product, which includes one or more computer-readable storage media and program instructions stored on the one or more computer-readable storage media to perform operations. The operations include executing a software stack on a plurality of computing systems. The operations further include monitoring, using one or more processors, the plurality of computing systems. The operations further include detecting one or more problems at different levels of the software stack. The operations further include generating, using one or more processors, a plurality of bug tickets for the different levels of the software stack based on the detected one or more problems. The operations further include tagging the plurality of bug tickets based on one or more rules. The operations further include assigning a resolve priority to each of the plurality of tagged bug tickets. The operations further include comparing the plurality of tagged bug tickets to each other to identify tagged bug tickets that result from a common problem in the software stack and adjusting the resolve priority of the identified tagged bug tickets based on a number of the identified tagged bug tickets.

### BRIEF DESCRIPTION OF THE DRAWINGS

FIG. 1 is a block diagram of an example computer environment for use in conjunction with one or more embodiments of architecture for adjusting priority for bug tickets.

FIG. 2 is a block diagram of an exemplary embodiment of adjusting priority of a plurality of bug tickets based on other existing bug tickets.

FIG. 3 is a flowchart illustrating an exemplary method for adjusting priority of a plurality of bug tickets based on other existing bug tickets.

FIG. 4 is a flowchart illustrating an exemplary method for determining relationships between computing systems at different levels of a software stack.

FIG. 5 is a flowchart illustrating an exemplary method for determining computing systems in different levels of a software stack that are related to a bug ticket.

FIG. 6 is a block diagram of an exemplary embodiment of determining computing systems in different levels of a software stack that are related to a bug ticket.

### DETAILED DESCRIPTION

The present disclosure depicts a software stack that communicates with a prioritizer for prioritizing tagged bug tickets. Software stacks can include different levels that each has a repository. By having separate repositories, different groups of people can work on each level of the stack without directly interfering with another level of the stack. However, when a bug occurs on a lower level of the stack, it may manifest differently in each of the higher-level services, resulting in each service creating their own bug ticket in their own repository with their own severities, which are often designated as low severity.

The present disclosure addresses the challenge of a problem existing in multiple levels of a software stack and resolving the problem is given a low priority. By checking for multiple bug tickets with a common problem, a checking system can adjust the severity and priority of the problem to better match how the software stack is being affected by the problem. Additionally, by checking the software stack for code related to or similar to the code that causes the problem, the checking system can proactively resolve undetected problems in levels of the software stack that have not generated a bug ticket. The checking system can form relationships between computing systems on different levels of the software stack before a problem occurs by introducing a test problem/bug into the software stack and monitoring the computing systems to see which computing systems react to the problem that is introduced. The relationships found can be stored and used for resolving future problems when one computing system of the relationship detects a problem and other computing systems in the relationship have not detected the problem.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as block 200 for adjusting priority of bug tickets for problems found in a software stack. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

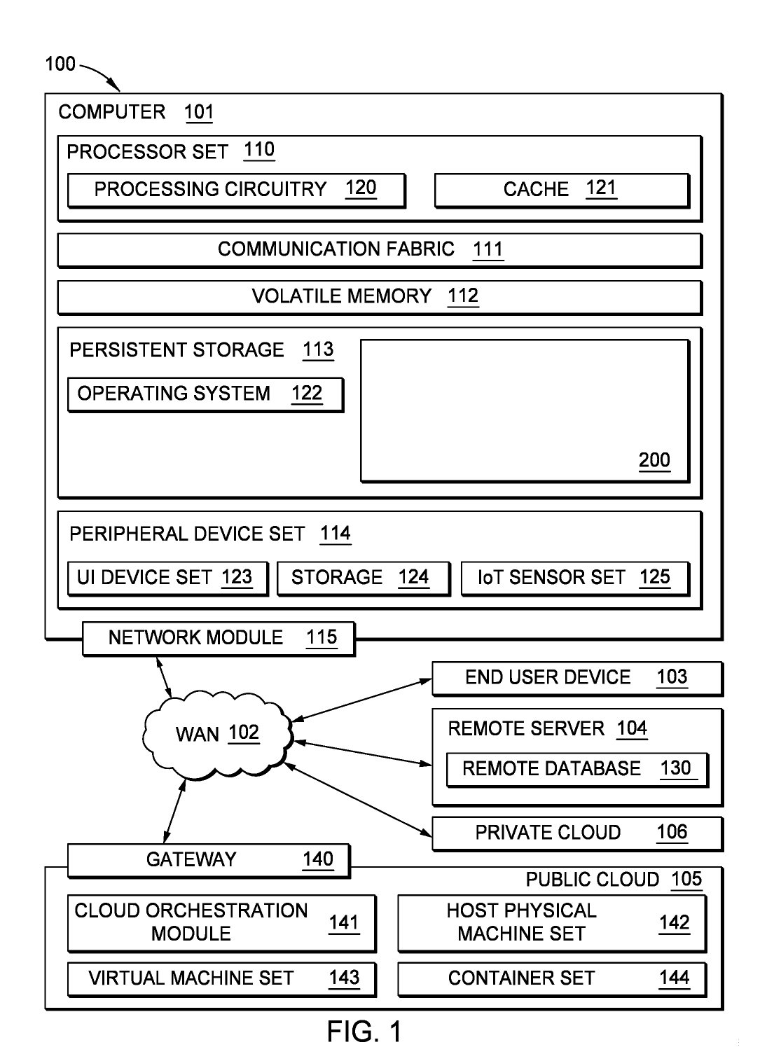

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

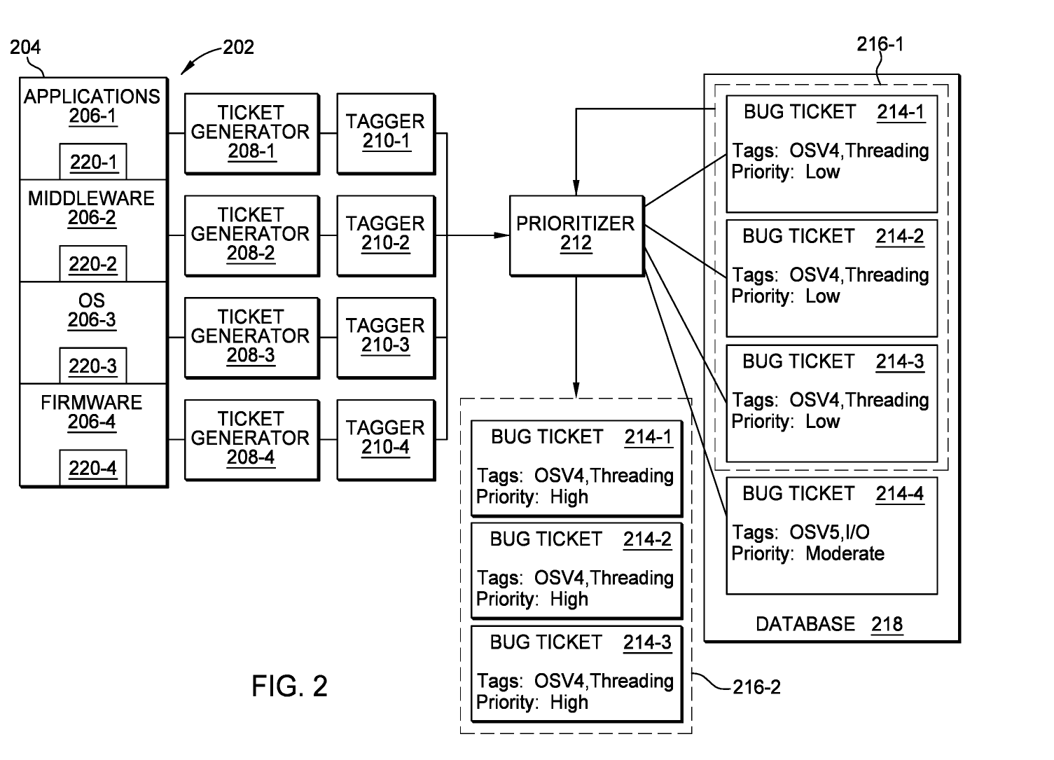

FIG. 2 depicts an exemplary embodiment of architecture 202 including a software stack along with ticket generators, taggers, a prioritizer, and a database. In an exemplary embodiment, the architecture 202 includes software stack 204, ticket generators 208-1 through 208-4, taggers 210-1 through 210-4, prioritizer 212, and database 218. The software stack 204 includes a plurality of separate levels that include different components to form a platform. In an exemplary embodiment, the software stack 204 has levels including applications level 206-1, middleware level 206-2, operating system (OS) level 206-3, and firmware level 206-4, which includes computing systems 220-1 through 220-4, respectively. The computing systems 220-1 through 220-4 can be used for, but are not limited to, running services, APIs, software, applications, etc. Each level of the software stack 204 may include a ticket generator that creates a bug ticket when a problem is detected in the level of the software stack 204. In one embodiment, the bug tickets created by a ticket generator are untagged and unprioritized bug tickets. In an exemplary embodiment, the applications level 206-1 includes the ticket generator 208-1, the middleware level 206-2 includes the ticket generator 208-2, the OS level 206-3 includes the ticket generator 208-3, and the firmware level 206-4 includes the ticket generator 208-4. In an exemplary embodiment, the applications level 206-1 creates bug ticket 214-1 using ticket generator 208-1, the middleware level 206-2 creates bug ticket 214-2 using ticket generator 208-2, the OS level 206-3 creates bug ticket 214-3 using ticket generator 208-3, and the firmware level 206-4 creates bug ticket 214-4 using ticket generator 208-4.

When one of the ticket generators creates a bug ticket, the bug ticket is sent to a tagger to be assigned tags related to the problem in the bug ticket. For example, the tags may include, but are not limited to, information about a computing system’s state, error codes, configurations options, versions of software on the computing system, or any combination thereof. These tags can be assigned manually or automatically through the use of machine learning models or artificial intelligence reading the bug ticket and determining tags related to information in the bug ticket. Similar to the ticket generators, each level may include a tagger. In an exemplary embodiment, the applications level 206-1 includes the tagger 210-1, the middleware level 206-2 includes the tagger 210-2, the OS level 206-3 includes the tagger 210-3, and the firmware level 206-4 includes the tagger 210-4. The taggers 210-1 through 210-3 add the tags OS version 4 (OSV4) and threading to the respective bug tickets 214-1 through 214-3, now tagged bug tickets 214-1 through 214-3. The tagger 210-4 adds the tags OS version 5 (OSV5) and I/O to the bug ticket 214-4, now tagged bug ticket 214-4.

In an exemplary embodiment, the tagged bug tickets 214-1 through 214-4 from the taggers 210-1 through 210-4 are sent to the prioritizer 212. The prioritizer 212 outputs the tagged bug tickets 214-1 through 214-4 with a priority indicating an order to resolve the tagged bug tickets 214-1 through 214-4 based on the severity of the problem in the tagged bug ticket 214-1 through 214-4. The priority assigned may be a number, such as from 1-10, a phrase, such as low, moderate, and high, or some combination thereof. A numerical priority, such as 9 out of 10, or a phrase, such as “high,” indicates that the problem needs to be resolved sooner than a problem with a priority of 2 out of 10 or “low.” In an exemplary embodiment, the prioritizer 212 outputs the tagged bug tickets 214-1 through 214-3 assigned with a “low” priority and the tagged bug ticket 214-4 assigned with a “moderate” priority. The tagged bug tickets 214-1 through 214-4 are output and stored in the database 218.

In an exemplary embodiment, the tagged bug tickets 214-1 through 214-4 output from the prioritizer 212 may be related to the same problem. Based on looking at the tags of the tagged bug tickets 214-1 through 214-4, the tagged bug tickets 214-1 through 214-4 with tags that are the same or similar may indicate that the tagged bug tickets 214-1 through 214-4 are related. In an exemplary embodiment, some of the tagged bug tickets 214-1 through 214-4 may be duplicate tickets or tickets from different levels of the software stack 204 that are related to the same problem. In an exemplary embodiment, related tagged bug tickets may be grouped together, either manually or automatically, and re-prioritized based on the number of related tagged bug tickets. In an exemplary embodiment, the tagged bug tickets 214-1 through 214-3 share the same tags OSV4 and threading. In one example, the tagged bug tickets 214-1 through 214-3 are grouped into group 216-1 and sent back to the prioritizer 212.

In an exemplary embodiment, when the prioritizer 212 receives a group of previously prioritized tagged bug tickets, such as the tagged bug tickets 214-1 through 214-4, the prioritizer 212 can adjust the priority for each of the previously prioritized tagged bug tickets in the group based on a number of tagged bug tickets in the group and an initial priority assigned to the tagged bug tickets. In an exemplary embodiment, the initial priority for each of the previously prioritized tagged bug tickets in the group may be different from one another. In an exemplary embodiment, the prioritizer 212 recognizes that there are three tagged bug tickets, the tagged bug tickets 214-1 through 214-3, and that each tagged bug ticket 214-1 through 214-3 had an initial priority of low. The prioritizer 212 outputs the re-prioritized tagged bug tickets 214-1 through 214-3 as group 216-2. Each of the tagged bug tickets, 214-1 through 214-3, is re-prioritized to a “high” priority and the group 216-2 is stored into database 218.

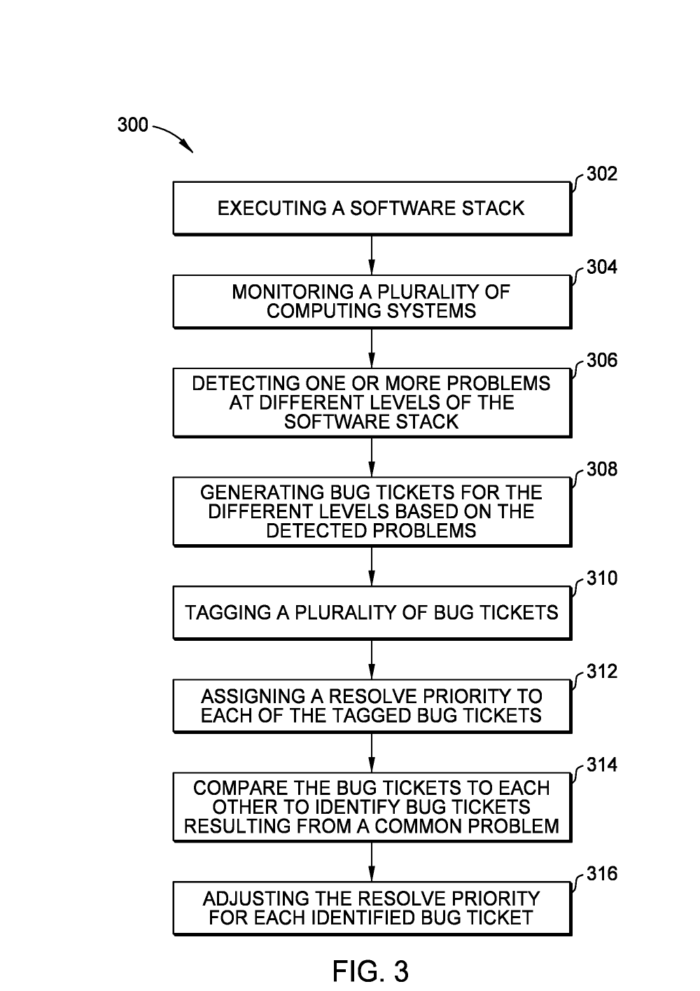

FIG. 3 depicts an exemplary embodiment of a method 300 for adjusting priority for tagged bug tickets. At block 302, the method 300 executes the software stack (e.g., the software stack 204 in FIG. 2) on a plurality of computing systems. In an exemplary embodiment, the software stack 204 includes the applications level 206-1, the middleware level 206-2, the OS level 206-3, and the firmware level 206-4. In an exemplary embodiment, each level of the software stack 204 can communicate with each other by sending data between the levels of the software stack 204. This communication can allow for one level to depend on information or code provided by a different level of the software stack 204. In an exemplary embodiment, the OS level 206-3 in the software stack 204 can communicate with the middleware level 206-2 and the firmware level 206-4. While each level being able to depend on other levels helps with communication, the dependence can also disrupt other levels if a problem occurs on another level.

At block 304, the method 300 monitors the plurality of computing systems in the software stack. As the plurality of computing systems are being monitored, problems can occur in one or more levels of the software stack. In an exemplary embodiment, a threading problem occurs in the applications level 206-1 of the software stack 204 and an I/O issue occurs in the firmware level 206-4 of the software stack 204.

At block 306, the method 300 detects one or more problems that occurred at different levels of the software stack. When a problem occurs in a level, a computing system on the level with the problem creates bug ticket describing the problem. The description of the bug ticket may include, but is not limited to, the time the problem was detected, version of an application related to the problem, level of the computing system, systems attached to the computing system at the time of the problem, etc. The bug ticket could be described manually by a user or automatically, such as by using a machine learning model. In an exemplary embodiment, a threading problem occurs in the applications level 206-1, middleware level 206-2, and OS level 206-3, and an I/O problem occurs in the firmware level 206-4. In an exemplary embodiment, each of these events occur simultaneously. In an exemplary embodiment, each event in the different levels occurs at different times.

At block 308, the method 300 generates bug tickets for different levels of the software stack based on the detected problems in each level. As the computing system in one of the levels in the software stack experiences a problem, the computing system generates a bug ticket for the problem using a ticket generator on the same level. In an exemplary embodiment, the computing system 220-1 on the applications level 206-1 creates the bug ticket 214-1 using the ticket generator 208-1, the computing system 220-2 on the middleware level 206-2 creates the bug ticket 214-2 using the ticket generator 208-2, the computing system 220-3 on the OS level 206-3 creates the bug ticket 214-3 using the ticket generator 208-3, and the computing system 220-4 on the firmware level 206-4 creates the bug ticket 214-4 using the ticket generator 208-4. Each of the tickets created by a ticket generator describes the problem, but the tickets do not have tags or a priority.

At block 310, the method 300 tags each bug ticket generated by one of the ticket generators 208-1 through 208-4 using one of the taggers 210-1 through 210-4. As shown in FIG. 2, each level of the software stack 204 can have a different tagger, the taggers 210-3, for tagging bug tickets. In an exemplary embodiment, as one of the taggers 210-1 through 210-4 receives the bug tickets, tags can be manually added or automatically added. In one embodiment, the tags are standardized across each level of the software stack 204 to ensure that tags assigned on one level are the same tags assigned on a different level of the software stack 204. In an exemplary embodiment, the taggers 210-1 through 210-3 add the tags OS version 4 (OSV4) and threading to the respective bug tickets 214-1 through 214-3. The tagger 210-4 adds the tags OS version 5 (OSV5) and I/O to the bug ticket 214-4. In an exemplary embodiment, the bug tickets output from the taggers 210-1 through 210-4 have the description of the problem and tags related to the problem, but in one embodiment, the bug tickets do not have a priority.

At block 312, the method 300 assigns a priority to of the tagged bug tickets based on the type of problem described. Unlike the ticket generators 208-1 through 208-4 and the taggers 210-1 through 210-4, in one embodiment, not every level of the software stack 204 has the prioritizer 212. In an exemplary embodiment, the software stack 204 may access the prioritizer 212 and send the tagged bug tickets 214-1 through 214-4 to the prioritizer 212 to determine a priority order for resolving the problems described in the tagged bug tickets 214-1 through 214-4. In an exemplary embodiment, a problem that does not have a significant impact on the level or the software stack 204, may be assigned “low” or a 2 out of 10 indicating that the problem does not need to be immediately resolved. In an exemplary embodiment, a problem that does have a significant impact on the level or software stack 204, may be assigned “high” or a 9 out of 10 indicating the problem should be resolved before any lower priority problems. In an exemplary embodiment, the prioritizer 212 outputs the tagged bug tickets 214-1 through 214-3 assigned with a “low” priority and the tagged bug ticket 214-4 assigned with a “moderate” priority.

At block 314, the method 300 compares the tagged bug tickets 214-1 through 214-4 to each other to identify bug tickets resulting from a common problem. Based on the tags assigned to each of the tagged bug tickets 214-1 through 214-4, the tagged bug tickets 214-1 through 214-4 are grouped with related tagged bug tickets. The groupings may be based on matching one or more tags of one tagged bug ticket to the tags of a different tagged bug ticket. In an exemplary embodiment, the tagged bug tickets 214-1 through 214-3 share the same tags OSV4 and threading. The tagged bug tickets 214-1 through 214-3 are grouped into group 216-1 and sent back to the prioritizer 212.

At block 316, the method 300 adjusts the priority for each identified bug ticket using the prioritizer 212. In an exemplary embodiment, the group of related tagged bug tickets are sent back to the prioritizer 212 to adjust the priority assigned to each of the related tagged bug tickets. The prioritizer 212 uses a number of the related tagged bug tickets along with the initial priority and a type of problem to determine an adjusted priority for the tagged bug tickets. In an exemplary embodiment, the prioritizer 212 determines that there are three related tagged bug tickets, the tagged bug tickets 214-1 through 214-3, and the initial priority for the tagged bug tickets was a “low” priority. The prioritizer 212 determines that given the problem being threading, along with the number of tickets, that the “low” priority should be adjusted to a “high” priority. The prioritizer 212 adjusts each priority for the tagged bug tickets 214-1 through 214-3 to be “high” priority.

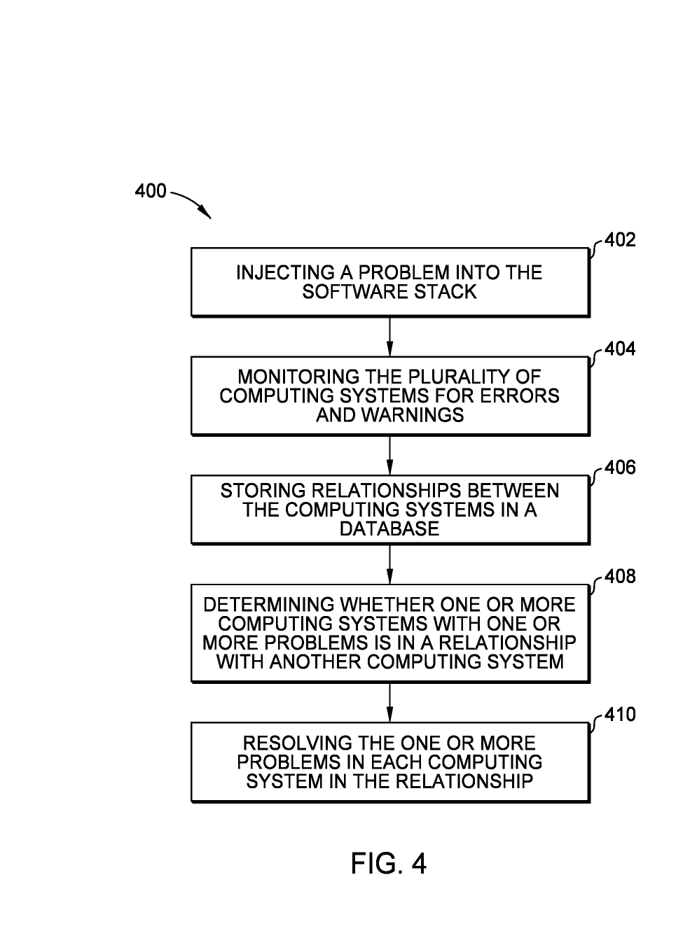

FIG. 4 depicts an exemplary embodiment of a method 400 for determining a relationship between computing systems for resolving problems that was detected in one of the computing systems, but not detected in the other computing systems in the relationship. In one embodiment, the method 400 in FIG. 4 may be performed before the method 300 in order to form relationships between computing systems throughout different levels of the software stack 204. Using the relationships between the computing systems, a problem indicated by a bug ticket can be resolved in each computing system in each relationship. At block 402, the method 400 injects a test problem into the software stack 204. In an exemplary embodiment, a test problem is injected in the computing system 220-3 on the OS level 206-3 of the software stack 204. In an exemplary embodiment, as the problem is injected into one level of the software stack 204, computing systems in each level of the software stack 204 may respond to the problem.

At block 404, the method 400 monitors the plurality of computing systems across each level of the software stack 204 for any errors or warnings in response to the injected test problem. As the test problem starts in one level of the software stack 204, other levels of the software stack 204 may start to detect problems caused by the test problem. In an exemplary embodiment, the software stack 204 monitors computing systems on each level, 206-1 through 206-4, to determine if a computing system on each level responds to the injected problem. In an exemplary embodiment, the software stack 204 determines the computing system 220-1 on applications level 206-1 and the computing system 220-2 on the middleware level 206-2 detected a problem in response to the test problem injected into the OS level 206-3.

At block 406, the method 400 stores a relationship between computing systems in the software stack 204 into the database 218. In an exemplary embodiment, when the software stack 204 detects a plurality of computing systems that are affected by the test problem, the relationship between the computing systems is stored in the database 218. In some embodiments, the database 218 may be a wreckage database or fallout database, which includes, but is not limited to, tagged bug tickets (e.g., the tagged bug tickets 214-1 through 214-4), relationships between computing systems (e.g., the computing systems 220-1 through 220-4), or specific configurations for the software stack 204. In an exemplary embodiment, the relationship between the computing systems 220-1 through 220-3 is stored in the database 218.

At block 408, the method 400 determines whether one or more computing systems are in a relationship with another computing system. When one computing system detects a problem, a bug ticket is made for the problem. However, the problem may be in another level, but the problem has not been detected yet. In an exemplary embodiment, a checking system may use the relationship found in block 404 to check if the other computing systems would be affected by the problem. In an exemplary embodiment, the computing system 220-3 in the OS level 206-3 detects an overflow problem and creates a bug ticket. The checking system determines that the computing system 220-3 in the OS level 206-3 is connected to the computing system 220-2 in the middleware level 206-2 and the computing system 220-1 in the applications level 206-1 based on the relationship found in block 404.

At block 410, the method 400 resolves the one or more problems in each computing system in the relationship. When resolving a bug ticket, the problem may be resolved in the computing system that initiated the bug ticket. However, by having a relationship between an initiating computing system and other computing systems, the problem can be resolved in each computing system in the relationship. In an exemplary embodiment, the overflow problem is resolved in the computing system 220-3 on the OS level 206-3 along with the computing system 220-2 in the middleware level 206-2 and the computing system 220-1 applications level 206-1.

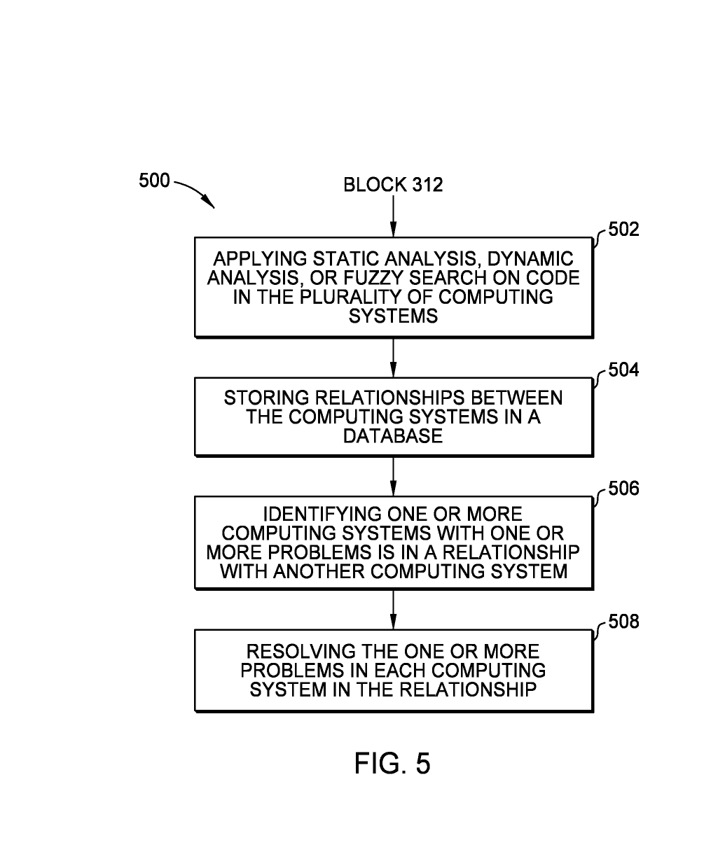

FIG. 5 depicts an exemplary embodiment of a method 500 for determining a relationship between computing systems after a bug ticket is created for a problem. After a tagged bug ticket is given a priority in block 312 of FIG. 3, the method 500 may find other computing systems related to the computing system that detected the problem in the tagged bug ticket. At block 502, the method 500 applies a static analysis, dynamic analysis, or fuzzy search on code in each computing system in the software stack 204. A static analysis searches code on a computing system without running the code. A dynamic analysis searches the code as the code runs on the computing system. A fuzzy search on the code looks for code that has similar function but may not be the exact same code. In an exemplary embodiment, the checking system does a combination of a static analysis, a dynamic analysis, and a fuzzy search. In an exemplary embodiment, after the prioritizer 212 prioritizes a tagged bug ticket from the OS level 206-3 of the software stack 204, the checking system checks code for each computing system in each level of the software stack 204 using a fuzzy search. The code in the computing system 220-3 on the OS level 206-3 is “X+Y = Z1” and checks the computing systems of each other level for similar code. The checking system finds that the computing system 220-2 on the middleware level 206-2 has the code “A+B = Z1” and the computing system 220-1 on the applications level 206-1 has the code “J+K = Z1.” The checking system determines there is a relationship between the respective computing systems 220-1 through 220-3 on the applications level 206-1, the middle level 206-2, and the OS level 206-3.

At block 504, the method 500 stores the relationship between the computing systems in the database 218. In an exemplary embodiment, when the software stack 204 uses the static analysis, dynamic analysis, or fuzzy search to determine related computing systems, the relationship between the computing systems is stored in the database 218. In an exemplary embodiment, the relationship between the computing systems 220-1 through 220-3 is stored in the database 218.

At block 506, the method 500 determines whether one or more computing systems is in a relationship with another computing system. In an exemplary embodiment, when one computing system in the software stack 204 detects a problem, a bug ticket is made for the problem. In an exemplary embodiment, the problem exists in another level, but the problem has not been detected yet. The checking system uses the relationship found in block 502 to check if the other computing systems would be affected by the problem. In an exemplary embodiment, the computing system 220-3 in the OS level 206-3 detects an I/O problem and creates a bug ticket. The checking system determines that the computing system 220-3 in the OS level 206-3 is connected to the computing system 220-2 in the middleware level 206-2 and the computing system 220-1 in the applications level 206-1.

At block 508, the method 500 resolves the one or more problems in each computing system in the relationship. By having a relationship between an initiating computing system and other computing systems, the problem is resolved in each computing system. In an exemplary embodiment, the I/O problem is resolved in the computing system 220-3 on the OS level 206-3 along with the computing system 220-2 in the middleware level 206-2 and the computing system 220-1 in the applications level 206-1.

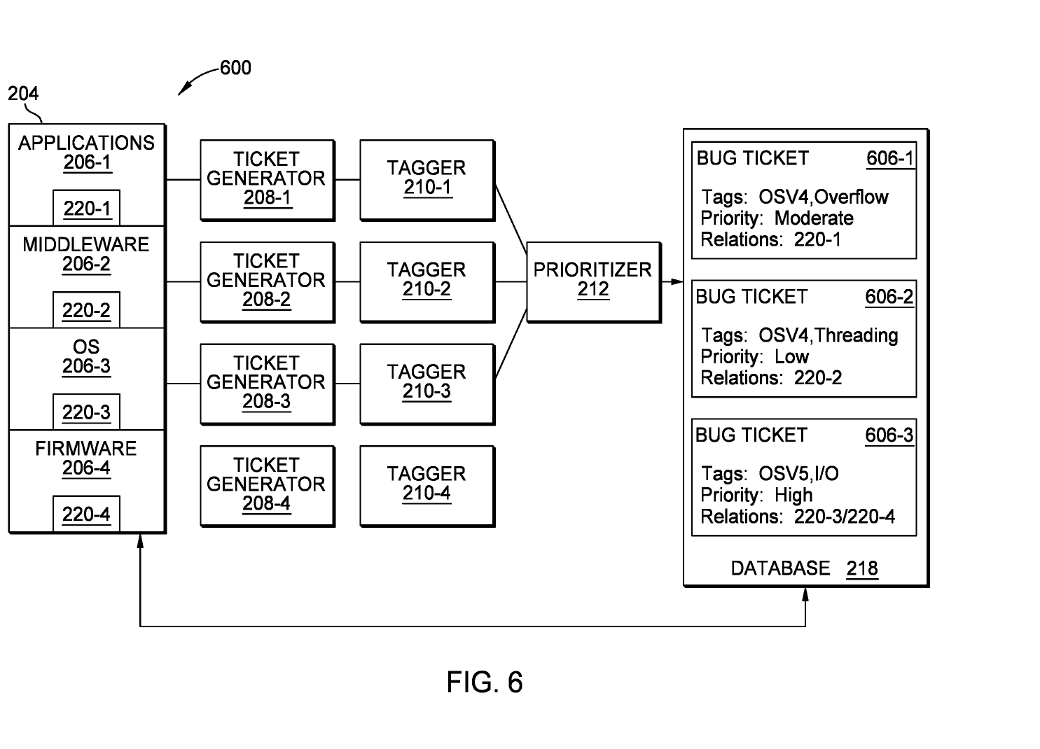

FIG. 6 depicts an architecture 600 including the software stack 204 along with the ticket generators 208-1 through 208-4, the taggers 210-1 through 210-4, the prioritizer 212, and the database 218. In an exemplary embodiment, one level of the software stack 204 may detect a problem that may impact another level of the software stack 204, but the other level of the stack 204 has not detected the problem. The architecture 600 may connect the other level of the software stack 204 to a bug ticket created by the level that detected the problem. In an exemplary embodiment, the architecture 600 includes the software stack 204, the ticket generators 208-1 through 208-4, the taggers 210-1 through 210-4, the prioritizer 212, and the database 218. The software stack 204 includes a plurality of separate levels that includes different components to form a platform. In an exemplary embodiment, the software stack 204 has levels including applications level 206-1, middleware level 206-2, OS level 206-3, and firmware level 206-4, which includes computing system 220-1 through 220-4, respectively. As described above, each level of the software stack 204 includes a ticket generator and tagger. In an exemplary embodiment, the ticket generator 208-1 creates bug ticket 606-1 and is tagged for OSV4 and overflow. The ticket generator 208-2 creates bug ticket 606-2 and is tagged for OSV4 and threading. The ticket generator 208-3 creates bug ticket 606-3 and is tagged for OSV5 and I/O.

In an exemplary embodiment, the prioritizer 212 assigns a “moderate” priority to the tagged bug ticket 606-1, “low” priority to the tagged bug ticket 606-2, and “high” priority to the tagged bug ticket 606-3. Each bug ticket is stored in the database 218. For each bug ticket, the checking system may use a static analysis, dynamic analysis, or fuzzy search on code of the computing systems in the software stack 204 to determine if code on one of the computing systems is similar to the code of the computing system that detected the problem. In an exemplary embodiment, the checking system uses a fuzzy search to check if the code on the on the computing systems 220-1, 220-2, or 220-4 are related to code of computing system 220-3, the computing system that detected the problem for the tagged bug ticket 606-3. The checking system determines that the computing system 220-4 on the firmware level 206-4 has code related to the code on the computing system 220-3, so the relationship is stored in the database 218.

Relationships can also be determined based on previous, resolved bug tickets. In one embodiment, when a computing system (e.g., the computing systems 220-1 through 220-4 in FIG. 2) experiences an issue, the checking system can compare the issue experience by the computing system to an issue in a previous, resolved bug ticket (e.g. the tagged bug tickets 214-1 through 214-4 in FIG. 2). In certain embodiments, the relationships may be determined by reported component problems in one of the computing systems by a user or administrator.

While the foregoing is directed to embodiments of the present invention, other and further embodiments of the invention may be devised without departing from the basic scope thereof, and the scope thereof is determined by the claims that follow.

What is claimed is:

1. A method comprising:
executing a software stack on a plurality of computing systems;
detecting one or more problems at different levels of the software stack by monitoring the plurality of computing systems;
generating, using one or more processors, a plurality of bug tickets for the different levels of the software stack based on the detected one or more problems;
tagging the plurality of bug tickets based on one or more rules;
assigning a resolve priority to each of the plurality of tagged bug tickets;
comparing the plurality of tagged bug tickets to each other to identify tagged bug tickets that result from a common problem in the software stack; and
adjusting the resolve priority of the identified tagged bug tickets based on a number of the identified tagged bug tickets.

2. The method of claim 1, further comprising:
prior to detecting the one or more problems, injecting a problem into the software stack;
monitoring the plurality of computing systems in the software stack for errors and warnings;
storing relationships between the plurality of computing systems in a wreckage database based on the monitored errors and warnings;
in response to detecting the one or more problems, determining whether one of the plurality of computing systems with the one or more problems are in a relationship with another computing system; and
in response to determining one of the plurality of computing systems with the one or more problems is in a relationship with another computing system, resolving the one or more problems in each computing system in the relationship.

3. The method of claim 1 further comprises:
in response to prioritizing the plurality of tagged bug tickets, applying static analysis, dynamic analysis, or fuzzy search on code in each of the plurality of computing systems related to the plurality of tagged bug tickets to determine code related to an issue in the plurality of tagged bug tickets;
storing a relationship between the plurality of computing systems that are related to one of the plurality of tagged bug tickets;
identifying the code for one of the plurality of computing systems that did not generate a bug ticket is related to one of the plurality of tagged bug tickets; and
in response to identifying the one or computing systems related to one of the plurality of tagged bug tickets, resolving the one or more problems in each computing system in the relationship.

4. The method of claim 1 further comprises in response to adjusting the resolve priority of the identified tagged bug tickets, resolving a bug related to the identified tagged bug tickets in a level different from the levels that detected the one or more problems.

5. The method of claim 1 further comprises sending an update notification to an administrator with information related the resolve priority for a subset of the plurality of tagged bug tickets that are from different levels of the software stack.

6. The method of claim 1 further comprises assigning tags, using a standardized set of rules, to a plurality of untagged bug tickets based on a type of problem associated with a bug.

7. The method of claim 1 further comprises storing a relationship between the plurality of computing systems related to either the identified tagged bug tickets in a database or previous, resolved bug tickets in the database.

8. A computer system comprising:
a processor set;
one or more computer-readable storage media; and
program instructions stored on the one or more computer-readable storage media to cause the processor set to perform operations comprising:
executing a software stack on a plurality of computing systems;
monitoring, using one or more processors, the plurality of computing systems;
detecting one or more problems at different levels of the software stack;
generating, using the one or more processors, a plurality of bug tickets for the different levels of the software stack based on the detected one or more problems;
tagging the plurality of bug tickets based on one or more rules;
assigning a resolve priority to each of the plurality of tagged bug tickets;
comparing the plurality of tagged bug tickets to each other to identify tagged bug tickets that result from a common problem in the software stack; and
adjusting the resolve priority of the identified tagged bug tickets based on a number of the identified tagged bug tickets.

9. The computer system of claim 8, further comprising:
prior to detecting the one or more problems, injecting a problem into the software stack;
monitoring the plurality of computing systems in the software stack for errors and warnings;
storing relationships between the plurality of computing systems in a wreckage database based on the monitored errors and warnings;
in response to detecting the one or more problems, determining whether one of the plurality of computing systems with the one or more problems are in a relationship with another computing system; and
in response to determining one of the plurality of computing systems are in a relationship, resolving the one or more problems in each computing system in the relationship.

10. The computer system of claim 8 further comprises:
in response to prioritizing the plurality of tagged bug tickets, applying static analysis, dynamic analysis, or fuzzy search on code in each of the plurality of computing systems related to the plurality of tagged bug tickets to determine code related to an issue in the plurality of tagged bug tickets;
storing a relationship between the plurality of computing systems that are related to one of the plurality of tagged bug tickets;
identifying the code for one of the plurality of computing systems that did not generate a bug ticket is related to one of the plurality of tagged bug tickets; and
in response to identifying the one or computing systems related to one of the plurality of tagged bug tickets, resolving the one or more problems in each computing system in the relationship.

11. The computer system of claim 8 further comprises in response to adjusting the resolve priority of the identified tagged bug tickets, resolving a bug related to the identified tagged bug tickets in a level different from the levels that detected the one or more problems.

12. The computer system of claim 8 further comprises sending an update notification to an administrator with information related the resolve priority for a subset of the plurality of tagged bug tickets that are from different levels of the software stack.

13. The computer system of claim 8 further comprises assigning tags, using a standardized set of rules, to a plurality of untagged bug tickets based on a type of problem associated with a bug.

14. The computer system of claim 8 further comprises storing a relationship between the plurality of computing systems related to either the identified tagged bug tickets in a database or previous, resolved bug tickets in the database.

15. A computer program product comprising:
one or more computer-readable storage media; and
program instructions stored on the one or more computer-readable storage media to perform operations comprising:
executing a software stack on a plurality of computing systems;
monitoring, using one or more processors, the plurality of computing systems;
detecting one or more problems at different levels of the software stack;
generating, using the one or more processors, a plurality of bug tickets for the different levels of the software stack based on the detected one or more problems;
tagging the plurality of bug tickets based on one or more rules;
assigning a resolve priority to each of the plurality of tagged bug tickets;
comparing the plurality of tagged bug tickets to each other to identify tagged bug tickets that result from a common problem in the software stack; and
adjusting the resolve priority of the identified tagged bug tickets based on a number of the identified tagged bug tickets.

16. The computer program product of claim 15, wherein the operations further comprise:
prior to detecting the one or more problems, injecting a problem into the software stack;
monitoring the plurality of computing systems in the software stack for errors and warnings;
storing relationships between the plurality of computing systems in a wreckage database based on the monitored errors and warnings;
in response to detecting the one or more problems, determining whether one of the plurality of computing systems with the one or more problems are in a relationship with another computing system; and
in response to determining one of the plurality of computing systems are in a relationship, resolving the one or more problems in each computing system in the relationship.

17. The computer program product of claim 15, wherein the operations further comprise:
in response to prioritizing the plurality of tagged bug tickets, applying static analysis, dynamic analysis, or fuzzy search on code in each of the plurality of computing systems related to the plurality of tagged bug tickets to determine code related to an issue in the plurality of tagged bug tickets;
storing a relationship between the plurality of computing systems that are related to one of the plurality of tagged bug tickets;
identifying the code for one of the plurality of computing systems that did not generate a bug ticket is related to one of the plurality of tagged bug tickets; and
in response to identifying the one or computing systems related to one of the plurality of tagged bug tickets, resolving the one or more problems in each computing system in the relationship.

18. The computer program product of claim 15, wherein the operations further comprise in response to adjusting the resolve priority of the identified tagged bug tickets, resolving a bug related to the identified tagged bug tickets in a level different from the levels that detected the one or more problems.

19. The computer program product of claim 15, wherein the operations further comprise sending an update notification to an administrator with information related the resolve priority for a subset of the plurality of tagged bug tickets that are from different levels of the software stack.

20. The computer program product of claim 15, wherein the operations further comprise assigning tags, using a standardized set of rules, to a plurality of untagged bug tickets based on a type of problem associated with a bug.
